(19) United States
(12) Patent Application Publication
(10) Pub. No.: US 2006/0291463 A1
(43) Pub. Date: Dec. 28, 2006

(54) Communication apparatus, control method therefor, computer readable information recording medium and communication destination apparatus type registration data

(75) Inventor: Kenji Ishii, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/255,951

(22) Filed: Oct. 24, 2005

(30) Foreign Application Priority Data
Jun. 24, 2005 (JP) 2005-184448

(51) Int. Cl. H04L 12/56

(52) U.S. Cl. 370/389

(57) ABSTRACT

A communication destination apparatus type registering part is configured to register an apparatus type of a destination communication apparatus, and a function corresponding to an apparatus type of a destination communication apparatus is provided with the use of apparatus type information of the destination communication apparatus registered by said communication destination apparatus type registering part.

### BACKGROUND OF THE INVENTION

1. Field of the Invention

The present invention relates to a communication apparatus, a control method, a computer readable recording medium and a communication destination apparatus type registration data, and, in particular, to a communication apparatus, a control method therefor, a computer readable recording medium and a communication destination apparatus type registration data, for solving a problem concerning compatibility in functions between both communication apparatuses.

2. Description of the Related Art

Upon using a communication apparatus such as a cellular phone, a user may feel inconvenience due to a mismatch between communication apparatuses of both sides.

For example, when a communication message is sent to a communication destination with the use of an electronic mail function, the number of characters displayed each line on a screen of the destination communication apparatus is different from those of the source communication apparatus. In such a case, the communication massage, which the user who sends it produces on the source communication apparatus, may be different in an appearance from that which can be viewed by a user who receives the same on the destination communication apparatus.

Especially, when a table or a picture is produced from characters for several lines and a line feeding position is different between the communication apparatuses of both sides due to a difference in a page display function therebetween, the table or the picture may not be displayed in an originally intended manner on the destination communication apparatus.

Further, when a user whose cellular phone has a TV phone function applies a so-called character phone function for sending a message with the use of a predetermined character image, such a communication cannot be properly achieved if a destination communication apparatus does not have a TV phone function.

Furthermore, when a communication applying a so-called chat mail function is made, this communication cannot be achieved properly if a destination communication apparatus does not have the corresponding function.

Japanese Laid-open Patent Applications Nos. 2001-127873 and 2002-259281 disclose related arts.

### SUMMARY OF THE INVENTION

The present invention has been devised in consideration of such these problems, and an object of the present invention is to provide a communication apparatus and a control method therefor, avoidable of a possible inconvenience otherwise occurring when a specific function is different since an apparatus type of a destination communication apparatus is different from that of a source communication apparatus.

In order to achieve the object, according to the present invention, apparatus type information of a destination communication apparatus is registered, and then, when a communication is actually made with the destination communication apparatus, a function corresponding to the apparatus type of the destination communication apparatus can be applied with the use of the thus-registered information.

As a result, a user can have information concerning a function of a destination communication apparatus in a stage prior to actually carrying out a communication therewith. The user may use this information to carry out a communication in a manner corresponding to the function of the destination communication apparatus, and thus, an inconvenience otherwise occurring due to a difference in functions between the communication apparatuses of both sides can be avoided.

Other objects and further features of the present invention will become more apparent from the following detailed description when read in conjunction with the accompanying drawings:

### BRIEF DESCRIPTION OF THE DRAWINGS

FIG. 1 shows a block diagram of a software configuration of a cellular phone in one embodiment of the present invention;

FIG. 2 illustrates a destination apparatus type registering function according to the present invention in the configuration shown in FIG. 1;

FIGS. 3A and 3B show a state transition between an edit mail mode and an edit main body mode in the cellular phone shown in FIG. 1;

FIGS. 4 and 5 show a flow chart of operation for a transition from a display mail mode to the edit main body mode in the state transition shown in FIG. 3A;

FIGS. 6 and 7 show a flow chart of operation for a transition from the edit main body mode to a decorated mail function selected mode in the state transition shown in FIG. 3B;

FIGS. 8 and 9 show a flow chart of operation for a transition from the edit main body mode to the decorated mail function selected mode via a destination display mode in the state transition shown in FIG. 3B;

FIG. 10 shows a configuration example of an apparatus type DB according to the embodiment of the present invention;

FIGS. 11 and 12 show another flow chart of operation for a transition from the edit main body mode to the decorated mail function selected mode via a destination display mode in the state transition shown in FIG. 3B; and

FIG. 13 shows a configuration example of a phone book DB according to the embodiment of the present invention.

### DETAILED DESCRIPTION OF THE PREFERRED EMBODIMENT

First, functions of an embodiment of the present invention are described generally with reference to actual examples.

As an efficient communication preparation, for example, upon producing electronic mail message, it is preferable that a mail producing page corresponding to a function of an apparatus type of a destination cellular phone is displayed. When such an environment is provided, it is possible to avoid an inconvenience that a picture produced by means of characters in consideration of a width of a page is not properly displayed on a destination cellular phone since a width of a page of the destination cellular phone is shorter than that of a source cellular phone. That is, in this case, by displaying a page according to a page configuration and a font size of the destination cellular phone, it is possible to produce an electronic mail in an appearance obtained in the destination cellular phone.

Further, by previously registering an apparatus type of a destination cellular phone, it is possible to determine whether or not the destination cellular phone has a TV phone function. As a result, when a user makes input operation to carry out so-called character phone transmission to a destination cellular phone not having a TV phone function, the user is given a caution with a dialog indicating NA, before actually carrying out signal transmission.

Further, when a registration to a chat mail group is made, a matter that ‘a destination cellular phone does not have a function for a chat mail display’ can be previously notified of.

In order to achieve these functions, the following specific items A, B and C are employed:

A. A phone book function of a cellular phone is extended to have a function of registering not only a telephone number or such of a destination cellular phone but also an apparatus type of the same.

B. A database is provided in which a list of respective apparatus types of destination cellular phones is stored, and also, another database is provided in which specific functions and performances (capabilities) of the respective apparatus types of these cellular phones are stored.

C. A configuration is provided by which, when a user designates a destination cellular phone with which a communication is made from now by the own cellular phone, these databases are searched, the functions/performances (capability) of the registered apparatus type of the relevant cellular phone are obtained therefrom, and the specific contents of processing are properly selected or whether or not processing is applicable is properly determined according to the functions/performances (capability) of the destination cellular phone thus obtained.

The term a ‘destination communication apparatus’ a ‘destination cellular phone’ or simply ‘destination’ means a communication apparatus or a cellular phone, or a person on the other side with which a user makes a communication with the use of an own communication apparatus or cellular phone on one side, throughout the specification and claims of the present application. In this case, the communication made between both sides is not limited to an electronic mail or such, i.e., a unidirectional communication, but also may include a simple phone call, i.e., a bidirectional communication.

The embodiment of the present invention is described now in details with reference to figures.

As functions which are in particular directly relevant to the present invention, from among those of a cellular phone in an embodiment a communication apparatus of the present invention are listed below, i.e., items (1) through (7).

It is noted that the cellular phone in the embodiment of the present invention may have, other than those, a well-known phone book function, an electronic mail function, a chat mail function, a decorated mail (HTML mail) function, a character phone function, a TV phone function, a call signal with melody (3D) processing function, and so forth.

(1) The phone book function of the cellular phone includes a function of not only registering a telephone number and so forth of a cellular phone as a destination communication apparatus but also an apparatus type of the cellular phone.

The phone book has information per person, and each person's data should not necessarily include only a single destination communication apparatus but may include a plurality of destination communication apparatuses. That is, person-basis basic apparatus type information or destination-basis apparatus type information, or both may be provided.

Further, in this case, after the person-basis basic apparatus type information is fixed, the destination-basis apparatus type information may automatically inherit the values of the person-basis basic apparatus type information as default ones, and may be updated appropriately.

(2) A database of a list of apparatus types of cellular phones is provided.

(3) A database is provided for storing information indicating functions/performances (capabilities) of the respective apparatus types of the cellular phones.

(4) A function is provided for searching these databases for obtaining functions/performances (capability) corresponding to a registered apparatus type, and determining the contents of processing according to the thus-obtained contents, or determining whether or not particular processing is actually applied.

By this function, it is determined whether or not a destination communication apparatus provides a TV phone function, and, when a user selects a ‘character phone’ transmission for an apparatus type not providing a TV phone function, a caution dialog of NA is displayed previously to the user.

Further, when a user registers in a ‘chat mail’ group, it is determined from a destination apparatus type whether or not the destination communication apparatus has a chat mail function, and, when the destination communication apparatus does not have a chat mail function, a caution message is previously notified of to the user, indicating that a chat mail display is not available in the destination communication apparatus'.

(5) The databases are searched, functions/performances (capability) of a registered apparatus type are obtained therefrom, and, according to the thus-obtained contents, an actual page display manner is determined. This function is provided to accompany the existing electronic mail function.

Specifically, on an electronic mail producing page, when a user selects a destination by means of the phone book function, function/performance (capability) information of the apparatus type of the destitution is obtained from the databases automatically. Then, a mail producing page is displayed in a manner corresponding thereto, or a mail producing page corresponding thereto is displayed. In this case, a page size limitation and so forth corresponding to the thus-obtained information of the destination apparatus type are displayed appropriately.

Further, also for limitation information such as a transmittable size range of an attached file, a determination is made therefor based on the destination apparatus type function/performance (capability) information, and, based on the determination result, a caution message or such may displayed to the user, indicating that such a large size of an attached filed is not allowed by a destination apparatus, appropriately.

(6) A function is provided for externally obtaining a database concerning the above-mentioned apparatus type information, and appropriately carrying out addition/updating of the current databases therewith.

(7) A function is provided for displaying, on a list page or a destination selecting page of a phone book display page, symbols (so-called ‘picto’ or such) indicating a TV phone applicability, a chat mail applicability, a QVGA image applicability, a HTML mail applicability, and so forth. For a case where this function is applied for the list page, and a person has a plurality of sets of apparatus type information, which of symbols should be displayed may be determined from a logical sum (OR) operation or such, carried out on the plurality of sets of apparatus type information, appropriately.

Thus, according to the embodiment of the present invention, registration of not only a phone number and so forth of a destination, but also apparatus type information is registered in a phone book. Then, a processing limitation, a page configuration, and so forth, are determined according to the registered apparatus type. Thereby, a service, suitable to an apparatus type of a communication destination, can be provided, and thus, user's operationality can be improved.

Next, a specific configuration of the embodiment of the present invention configured to achieve the above-mentioned functions is described with reference to figures.

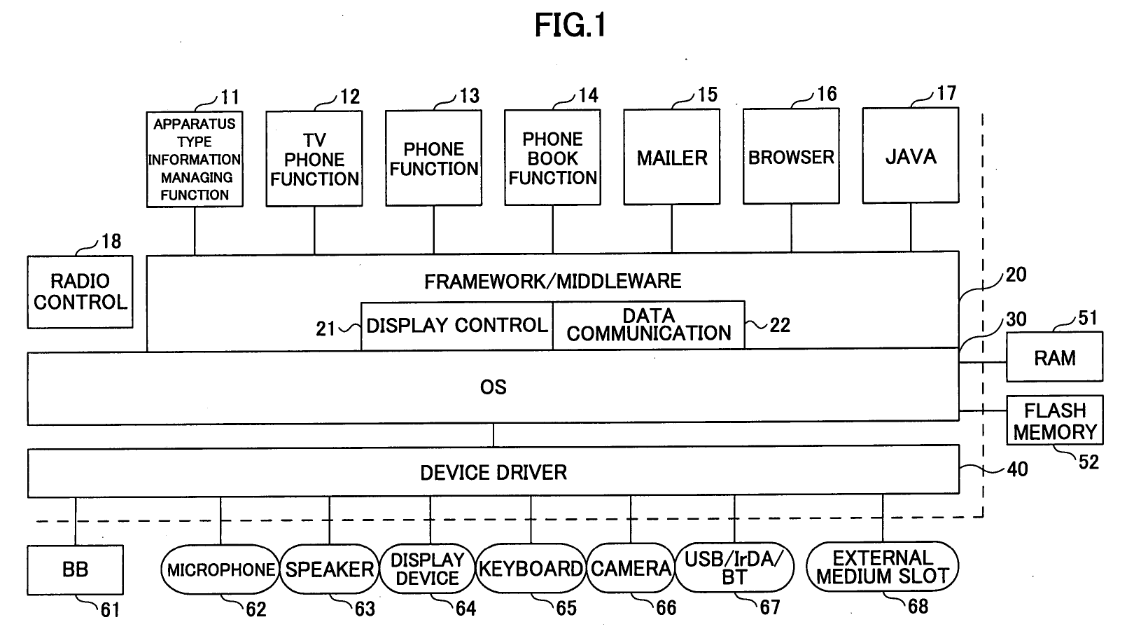

FIG. 1 shows a software configuration of the cellular phone in the embodiment of the present invention.

As shown, the software of the cellular phone includes a framework/middleware 20 operating under the control of an OS (operating system) 30. Further, the software includes, as particular application software, an apparatus type information managing function part 11, a TV phone function part 12, a phone function part 13, a phone book function part 14, a mailer 15, a browser 16, a Java (registered trademark) function part 17 and a radio control part 18, also operating under the control of the OS 30. The framework/middleware 20 includes a display control part 21 and a data communication part 22.

Each hardware part of the cellular phone is controlled via the OS 30 and a device driver 40. The hardware parts thus controlled include a broadband (BB) processing part 61, a microphone 62, a speaker 63, a display device 64, a keyboard 65, camera 66, a USB/IrDA/BT connection terminal 67, an external medium slot 68, and so forth.

Further, the OS 30 carries out data writing/reading to/from a RAM 51 and a flash memory 52 as the necessity arises.

The basic components of the software shown in FIG. 1 may have well-known configurations, except those especially described below.

In the cellular phone configured above, under the control of the OS 30, each particular application software 11 through 17 carries out various unique functions by means of a CPU (not shown) with the use of basic functions of the framework/middleware 20 including display control (21) and data communication (22) functions, and a radio transmission/reception function of the radio control part 18. As a result, a TV phone function (12), an ordinary phone function (13), a phone book function (14), an electronic mail function (mailer 15), a web browser function (16), a Java (registered trademark) function (17) and so forth, which are well-known as functions of a common cellular phone, are carried out. Various hardware parts 51, 52, 61 through 68 are applied appropriately for achieving these functions.

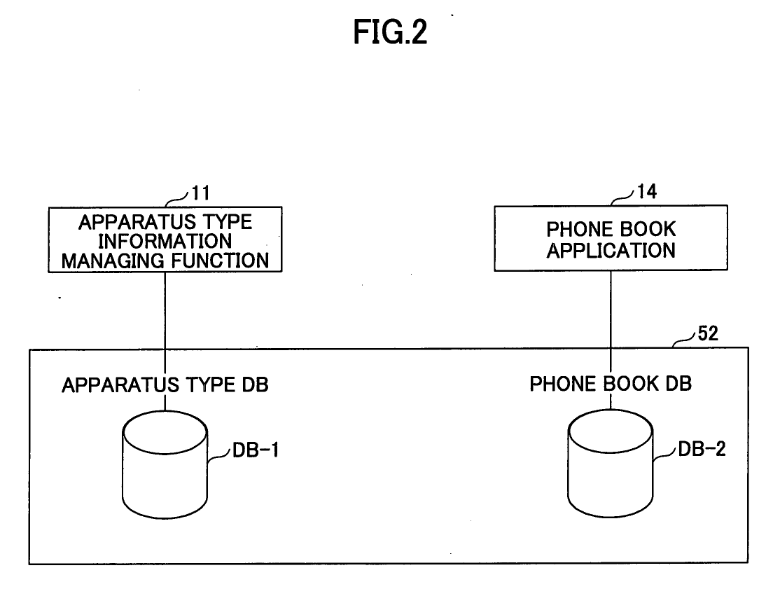

FIG. 2 shows the apparatus type information managing function part 11, the phone book function part 14 and the flash memory 52, which are parts of the embodiment of the present invention described above. The flash memory 52 stores an apparatus type DB, DB-1 and a phone book DB, DB-2, and, are managed by the apparatus type information managing part 11 and the phone book function part 14, respectively.

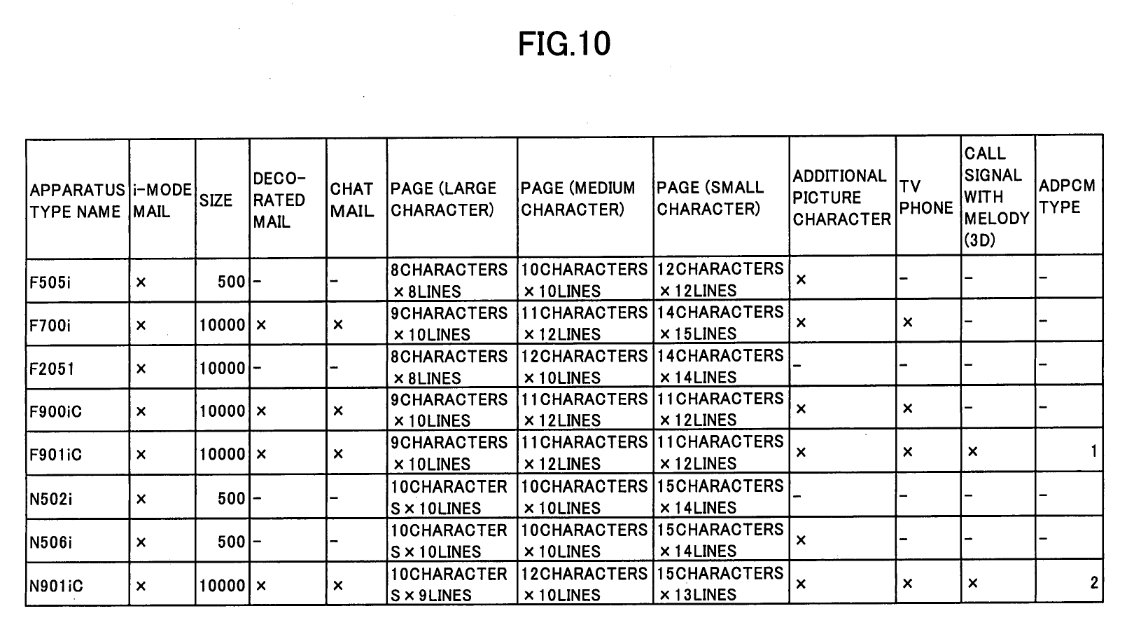

In the apparatus type DB, DB-1, as shown in FIG. 10 for example, functions/performances (capability) of a cellular phone is registered. Specifically, as shown in FIG. 10, this DB has information as to whether or not an electronic mail function is applicable, a maximum available data size for each electronic mail, whether or not a decorated mail function is applicable, whether or not a chat mail function is applicable, the displayable number of characters in a screen (for respective cases of a large character, a medium character and a small character), whether or not an additional picture character (or pictograph) function is applicable, whether or not a TV phone function is applicable, whether or not a call signal with memory (3D) function is applicable, whether or not an ADPCM function is applicable (and which type is available).

It is noted that the term ‘picture character (or pictograph)’ means, throughout the specification of the present application, either or both of one, created from a combination of a plurality of ordinary characters/letters/symbols, and one, which is a single special character/letter/symbol made of a picture.

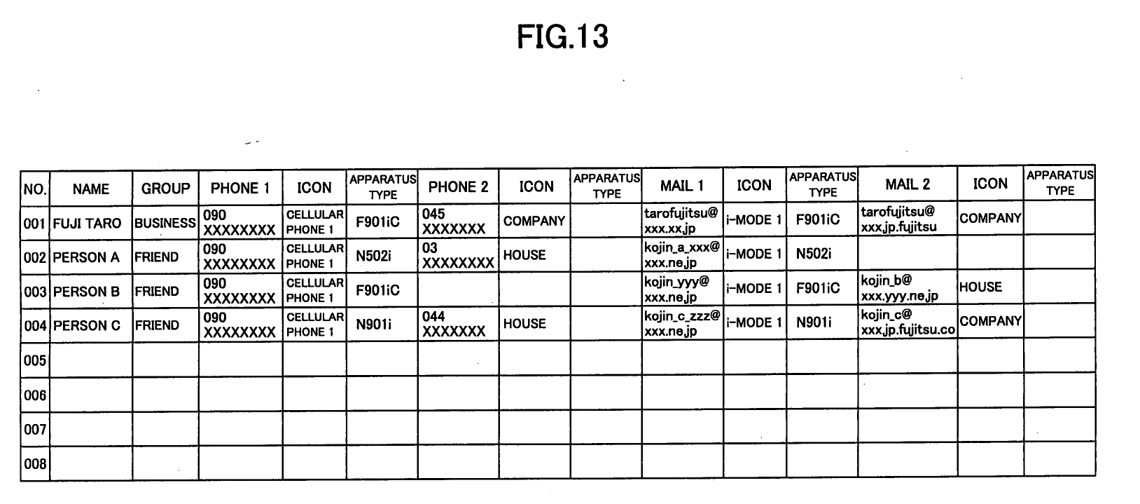

On the other hand, in the phone book DB, DB-2, as shown in FIG. 13 for example, a name of a communication destination, a pronunciation thereof, a grouping, a phone number (#1), a type thereof, a relevant apparatus type, a phone number (#2), a type thereof, a relevant apparatus type, a mail address for an electronic mail (#1), a type thereof, a relevant apparatus type, a mail address for an electronic mail (#2), a type thereof and a relevant apparatus type, are registered.

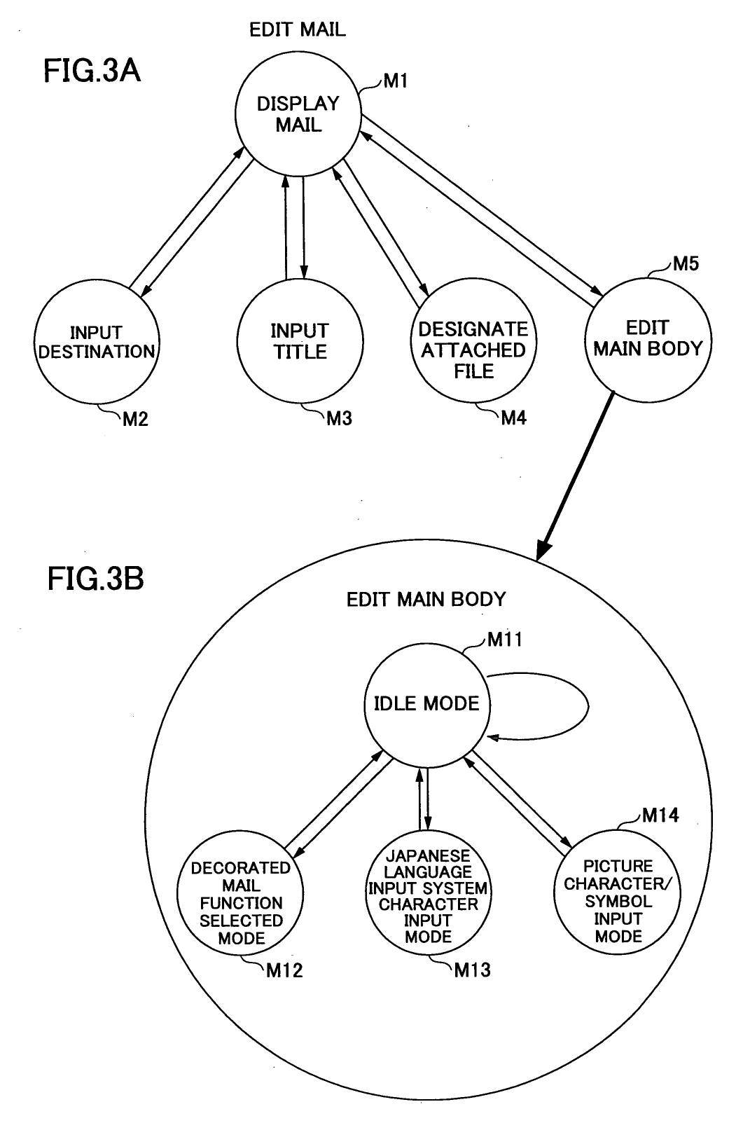

With reference to FIGS. 3A and 3B, operation of the electronic mail function is described now as a function of the cellular phone in the embodiment of the present invention described above.

FIG. 3A shows a state transition diagram concerning basic operation made when the electronic mail function is applied via the mailer 15.

In FIG. 3A, a mode M1 is a display mail mode, and is first entered when the electronic mail function is started up by a user. In this mode, information required for electronic mail production is displayed on the display device 64, the user operates the keyboard 65 with viewing this display, and therewith, the user can select an input destination mode M2, an input title mode M3, a designate attached file mode M4 or an edit main body mode M5,

As a result, the display is switched to a corresponding page of the thus-selected mode, the user may make predetermined operation on the thus-displayed page, and therewith, operation of inputting a destination for an electronic mail, inputting a title of the same, designating an attached file if any, or editing a main body of the electronic mail.

The electronic mail thus produced is converted into a radio signal by means of respective functions of the radio control part 18 and the broadband function part 61, initiated by the user's transmission instruction inputting operation. The thus-generated radio signal is transmitted externally from the cellular phone via an antenna (not shown.)

FIG. 3B shows a detailed state transition diagram of the edit main body mode M5 shown in FIG. 3A.

In this mode, an idle mode M11 occurs as a base point, and, then, with the user's instruction inputting operation, a Japanese language input system character input mode M13, a picture character (or pictograph)/symbol input mode M14 or a decorated mail function selected mode M12 may be entered therefrom. Further, with the user's instruction inputting operation, a ‘destination display’ mode, described below, may be entered.

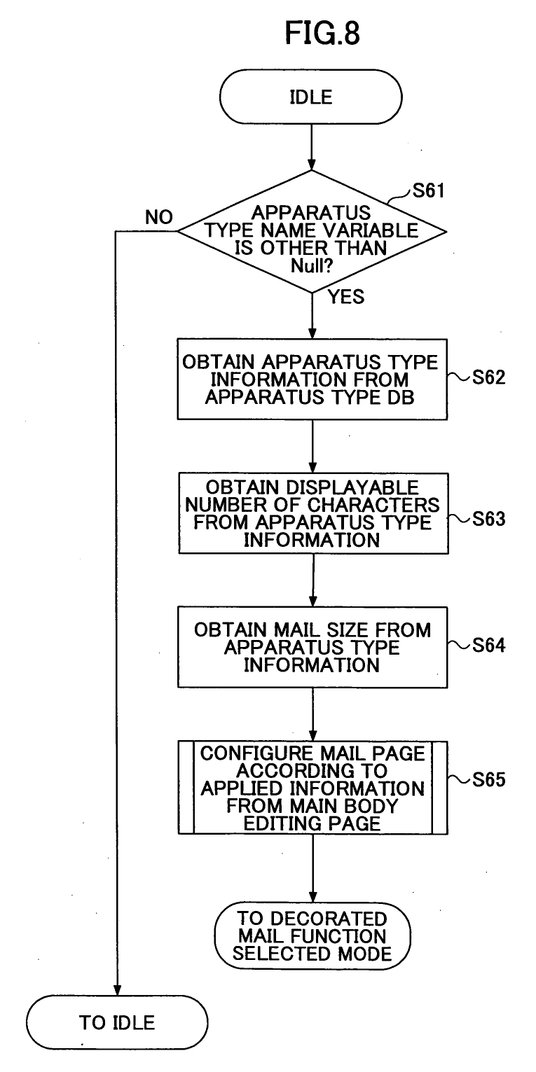

This destination display mode is a mode of displaying an entire configuration of the currently-produced electronic mail including a display of the destination of the electronic mail, on the display device 64. In this mode, as will be described later with reference to FIGS. 8 through 12, an electronic mail communication message (in a form of a mail page) produced until then is displayed in a style corresponding to a page display function of the destination apparatus type. Further, as will be described later, the decorated mail function selected mode M12 is automatically entered, with maintaining the display state of the same manner.

The Japanese language input system character input mode M13 is a mode for inputting ordinary characters with a so-called word processor function.

The picture character (or pictograph)/symbol input mode M14 is a mode for inputting special characters such as picture characters or pictographs, symbols and so forth.

The decorated mail function selected mode M12 is a mode for changing a size, a color or a background color of each character of a mail message, or inserting a special image/picture or such, in an electronic mail. An electronic mail thus decorated is called a ‘decorated mail’.

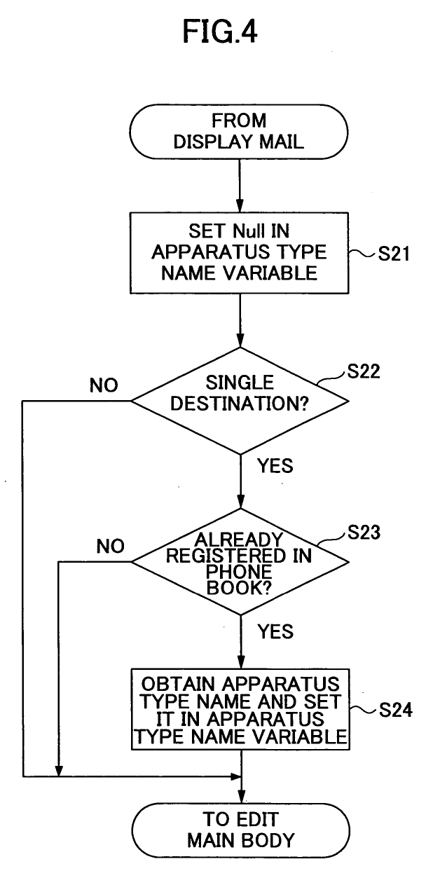

Next, with reference to FIGS. 4 through 13, operation of producing an electronic mail in the cellular phone in the embodiment of the present invention is described in detail.

FIG. 4 shows an operation flow when the edit main body mode is entered.

When an instruction is input for entering the edit main body mode M5 from the display mail mode M1 by a key operation of a user, a Null value is set in an apparatus type name variable in Step S21. Next, in Step S22, it is determined whether the number of destinations already set by the user in the input destination mode M2 is one or many.

When the determination result thereof is ‘many’, the edit main body mode M5 is entered. When the determination result is ‘one’, it is determined in Step S23 whether or not this destination is one already registered in the phone book DB, DB-2. When the destination has not been registered, the edit main body mode M5 is entered.

However, when the determination result of Step S22 is ‘already registered’, a corresponding apparatus type name is obtained from the phone book DB, DB-2 (see FIG. 13) in Step S24. Then, this is set in the above-mentioned apparatus type name variable. After that, the edit main body mode M5 is entered.

The above-described operation of FIG. 4 is for a case where the cellular phone does not have a ‘plurality of destination processing function’.

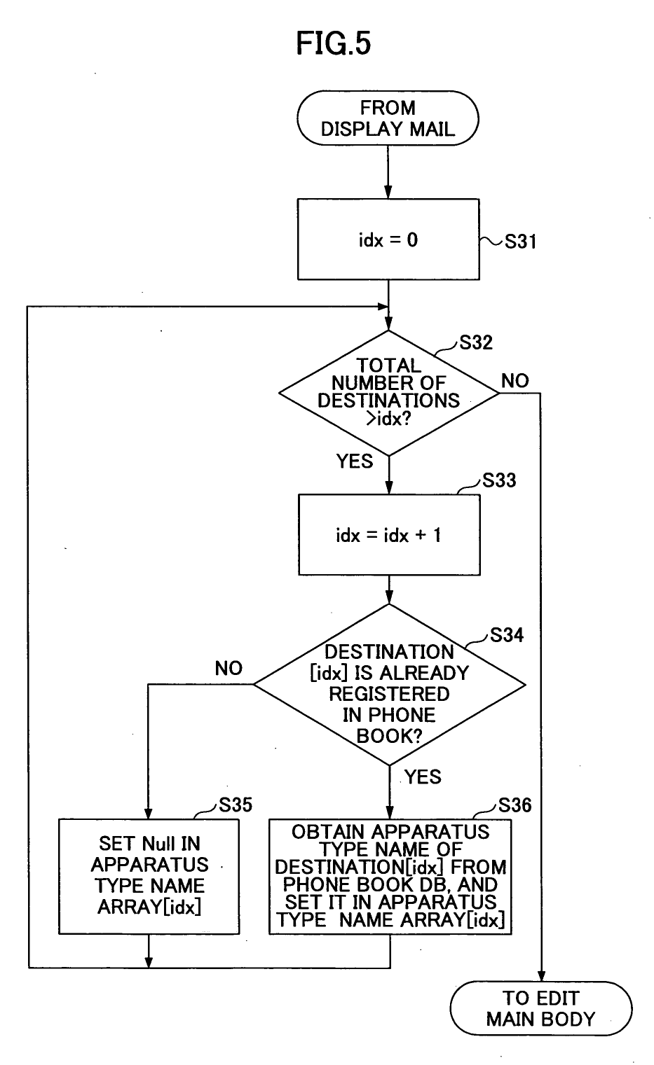

FIG. 5 shows operation for a case where the cellular phone has the ‘plurality of destination processing function’ by which special processing is carried out when an electronic mail having a plurality of destinations is handled, as described below.

In this case, when an instruction is input by the user's key operation for entering the edit main body mode M5 from the display mail mode M1, ‘0’ is set in a destination number variable (array variable) ‘idx’ in Step S31.

Then, in Step S32, it is determined whether or not the above-mentioned variable idx has reached the total number of destinations of the electronic mail, which is designated by the user in the input destination mode M2. When it has reached, the edit main body mode M5 is entered. When it has not reached, ‘1’ is added to the variable idx in Step S33.

Then, in Step S34, it is determined whether or not a destination corresponding to the number of the variable idx has been already registered in the phone book DB, DB-2. When it has not been registered, a Null value is set as apparatus type name variable corresponding to the current value of the variable idx in Step S35, and Step S32 is returned to. On the other hand, it is determined in Step S34 that it has been already registered, the relevant apparatus type is obtained from the phone book DB, DB-2 (see FIG. 13) in Step S36, the thus-obtained apparatus type name is set in the apparatus type name variable corresponding to the current value of the variable idx, and after that, Step S32 is returned to.

In Step S32, when the variable idx has reached the total number of destinations, the edit main body mode M5 is entered as mentioned above.

Thus, through the operation of FIG. 4 or FIG. 5, the phone book DB, DB-2 is automatically searched with the use of the electronic mail destination information as a key, the corresponding destination apparatus type is obtained therefrom, and the thus-obtained destination apparatus type information is set in the apparatus type variable, before the edit main body mode is entered.

It is noted that, an element of an array for setting the apparatus type name variable (simply referred to as an apparatus type name array, hereinafter) starts from 1, and this apparatus type name array has respective elements of destinations [1] through [the total number of destinations].

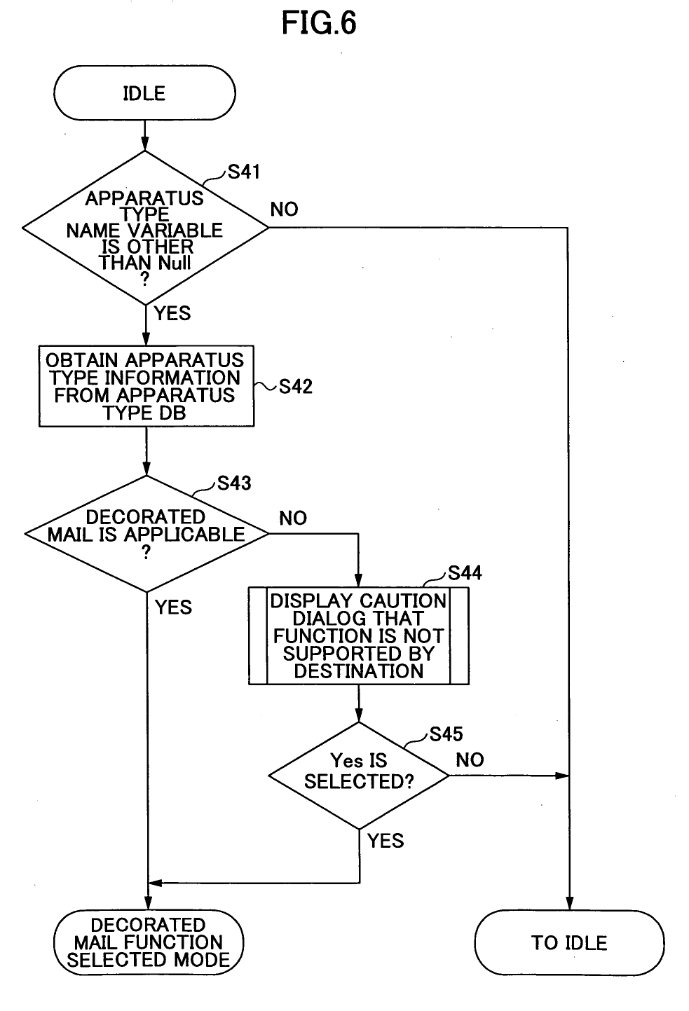

Next, operation of entering the decorated mail function selected mode M12 from the idle mode M11 (see FIG. 3B), after the edit main body mode M1 is entered, is described with reference to FIG. 6.

After the edit main body mode M5 is entered, when the user operates a key to input an instruction for entering the decorated mail function selected mode M12, data set in the apparatus type name variable in the operation described above with reference to FIG. 4 is referred to. When the thus-referred data is other than the Null value, the apparatus type name DB, DB-1 (see FIG. 10) is searched with the apparatus type name thus obtained from the apparatus typed name variable which is in Step S24 of FIG. 4, in Step S42. Then, in Step S43, it is determined therefrom whether or not the relevant apparatus type has the decorated mail function. When the result of the determination is that it has the function, the decorated mail function selected mode M12 is entered.

However, when the result of Step S43 is that it does not have the function, that is, when a value of a decorated mail item of FIG. 10 is ‘−’, a caution dialog that the function is not supported by the destination is displayed on the display device 64. It is noted that, in FIG. 10, in respective columns of ‘i-mode mail’, ‘decorated mail’, ‘chat mail’, ‘additional picture character’, ‘TV phone’, ‘call signal with melody (3D)’ and ‘ADPCM type’, a symbol ‘x’ means that a relevant function is applicable, while a symbol ‘−’ means that a relevant function is not applicable.

Then, after that, if the user input ‘Yes’ by a key operation (Step S45), the decorated mail function selected mode M12 is entered. Otherwise, the idle mode M11 is returned to.

It is noted that, operation of obtaining the apparatus type information in Step S42 may be carried out at the same time when the apparatus type name is obtained in Step S24 of FIG. 4.

FIG. 6 shows operation for a case where the cellular phone does not have the above-mentioned plurality of destination processing function.

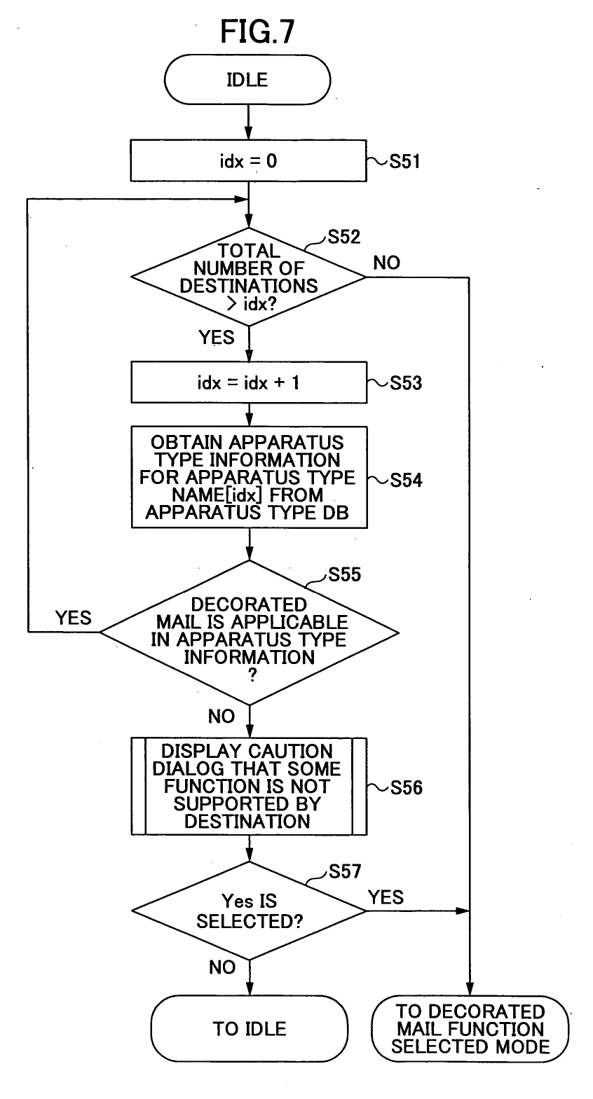

FIG. 7 shows operation for a case where the cellular phone has the plurality of destination processing function.

In this case, after the edit main body mode is entered, when the user operates a key to input an instruction for entering the decorated mail function selected mode M12, 0 is set in the above-mentioned variable idx in Step S51. After that, in Step S52, it is determined whether or not this variable idx has reached the total number of destinations.

When it has not reached in Step S52, the variable idx is incremented by 1 in Step S53. Then, in Step S54, the apparatus type name array is searched with the current value of the variable idx as a key. Thus, the apparatus type name, set in Step S35 or S36, is obtained therefrom, and, with the use of the apparatus type name as a key, corresponding apparatus type information is obtained from the apparatus type DB, DB-1. Then, in Step S55, it is determined whether or not the apparatus type information indicates that the apparatus type has the decorated mail function.

When it is determined that it has the decorated mail function, the decorated mail function selected mode M12 is entered. On the other hand, when it is determined that it does have the decorated mail function, i.e., the decorated mail item has a value of ‘−’ in FIG. 10, a caution dialog that the destination does not support the function is displayed on the display device 64 in Step S56. After that, when the user makes a key operation to input ‘Yes’ (Step S57), the decorated mail function selected mode M12 is entered. Otherwise, the idle mode M11 is returned to.

Operation of obtaining the apparatus type information in Step S54 may be carried out at the same time when the apparatus type name is obtained in Step S36 of FIG. 5.

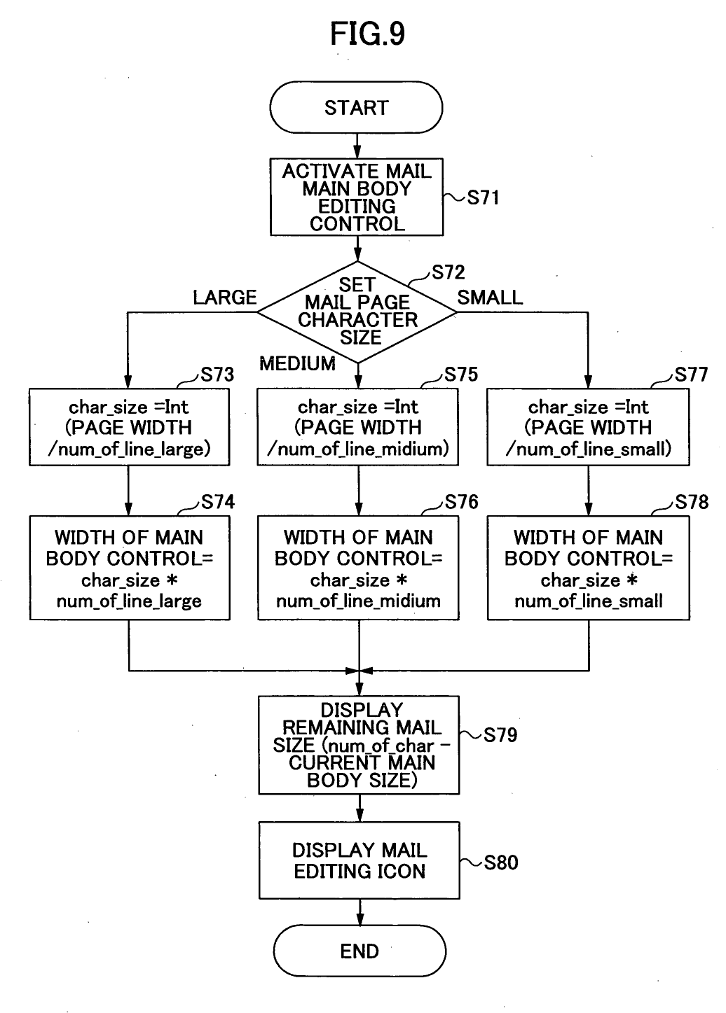

With reference to FIG. 9, the above-mentioned ‘destination display’ mode operation is described.

When the user’s key operation is made to input an instruction for carry out destination display mode operation in the idle mode M11 of the edit main body mode M5, it is determined in Step S61 whether or not the apparatus type name variable is effective (other than Null). When it is effective in Step S61, apparatus type data is referred to from the apparatus type DB, DB-1 (see FIG. 10) with the apparatus type name variable as a key in Step S62.

That is, in Step S63, from the apparatus type DB, DB-1, information concerning the displayable number of characters on each line is referred to. For example, for an apparatus type name N502i, num_of_line_large=10, num_of_line_medium=10, num_of_line_small=15 are obtained as corresponding information. These information are those obtained from respective items of FIG. 10 of the apparatus type DB, DB-1, i.e., ‘PAGE (LARGE CHARACTER)’, ‘PAGE (MEDIUM CHARACTER)’ and ‘PAGE (SMALL CHARACTER)’, respectively, and mean that ‘10 characters are displayable per line in a large character display mode’, ‘10 characters are displayable per line in a medium character display mode’, and ‘15 characters are displayable per line in a small character display made’, respectively.

Then, in Step S64, similarly, mail size information is obtained from the apparatus type DB, DB-1. For the apparatus type N502i, corresponding information is obtained as num_of_char=500. This value is obtained from the apparatus type DB, DB-1, by referring to the item of ‘SIZE’ of FIG. 10. This information means that the maximum number of characters accommodateable in a main body as a message of one electronic mail corresponds to 500 bytes.

Then, in Step S65, a mail page is configured in operation described later with reference to FIG. 9, and is displayed on the display device 64. That is , in FIG. 9, a mail main body control area is displayed on the display device 64 in Step S71. After that, in Step S72, information concerning a display character size, set by the user, is obtained.

When the thus-obtained display character size is a ‘large character’, a character size value for actually displaying characters on the display device 64 is obtained as a result of the mail main body displayable page width being divided by the above-mentioned set value of the variable num_of_line_large, i.e., the maximum displayable number of characters per line when applying the large character display mode, on the display device 64, in Step S73. Then, in Step S74, by multiplying the thus-obtained character size value with the above-mentioned maximum displayable number of characters per line, a width value of the mail main body control area for displaying a mail main body is obtained. A mail main body is displayed on the display device 64 according to this value.

Then, in Step S79, a value of a remaining available number of characters, i.e., a value of the number of characters which can be further inserted in the mail main body (corresponding to ‘remaining amount indication’, mentioned later), is obtained by subtracting the number of characters already inserted into the mail main body currently displayed on the display device 64 from the mail size value obtained in Step S64 of FIG. 8. The thus-obtained value is then displayed on the display device 64. Then, in Step S80, a mail editing icon is displayed on the display device 64.

The same manner is applied also for a case where a medium character display mode or a small character display mode is selected in Step S72. That is, when a display character size is a ‘medium character’, a character size value for actually displaying characters on the display device 64 is obtained as a result of the mail main body displayable page width being divided by the above-mentioned set value of the variable num_of_line_medium, i.e., the maximum displayable number of characters per line when applying the medium character display mode, on the display device 64, in Step S75. Then, in Step S76, by multiplying the thus-obtained character size value with the above-mentioned maximum displayable number of characters per line, a width value of the mail main body control area for displaying a mail main body is obtained. A mail main body is displayed on the display device 64 according to this value.

When a display character size is a ‘small character’, a character size value for actually displaying characters on the display device 64 is obtained as a result of the mail main body displayable page width being divided by the above-mentioned set value of the variable num_of_line_small, i.e., the maximum displayable number of characters per line when applying the small character display mode, on the display device 64, in Step S77. Then, in Step S78, by multiplying the thus-obtained character size value with the above-mentioned maximum displayable number of characters per line, a width value of the mail main body control area for displaying a mail main body is obtained. A mail main body is displayed on the display device 64 according to this value.

In Step S65, i.e., Steps S71 through S80, as mentioned above, the mail main body is displayed in such a style according to the apparatus type of the destination apparatus (cellular phone). Then, with the state being maintained as it is, the decorated mail function selected mode M12 is automatically entered. As a result, the user is allowed to produce a mail main body in such a state that, a style of a display which will occur in a display device of the destination cellular phone also occurs in the display device 64 of the own cellular phone.

Thus, according to the embodiment of the present invention, when a predetermined destination display mode operation is carried out during a user's producing of an electronic mail, a mail main body is displayed on the display device 64 of the own cellular phone automatically according to a requirement for the displayable number of characters per line of an apparatus type of a destination cellular phone which is set as a destination of the electronic mail, when the mail main body of the electronic mail in a currently reached state is displayed on the display device 64 of the own cellular phone. Therefore, at least as to the displayed number of characters per line, the mail main body thus displayed is displayed in the same style as that in which the same should be displayed on the display device of the destination cellular phone when the electronic mail is received by the destination cellular phone.

As a result, even for a case where a table, a picture character (or pictograph) or such, produced using a plurality of lines, is included in the mail main body, and that the displayed number of characters per line displayed on the display device 64 of the own cellular phone in the Japanese language input system character input mode M13 of the edit main body mode M5 is different from the displayed number of characters which should occur on the display device of the destination cellular phone, the user can positively recognize it before actually sending the electronic mail.

Or, instead, the user can produce, from the beginning, a mail main body in a display style the same as that of the destination, as a result of the user selecting the ‘destination display’ mode from the beginning of producing the mail main body of an electronic mail.

Thus, according to the present invention, it is possible to avoid a possible inconvenience that, an electronic mail is sent without recognizing a difference in a display style due to a difference in a display function between both apparatuses, and thus, a display of a picture character or a pictograph is not displayed in an expected manner, on the cellular phone of the receiver.

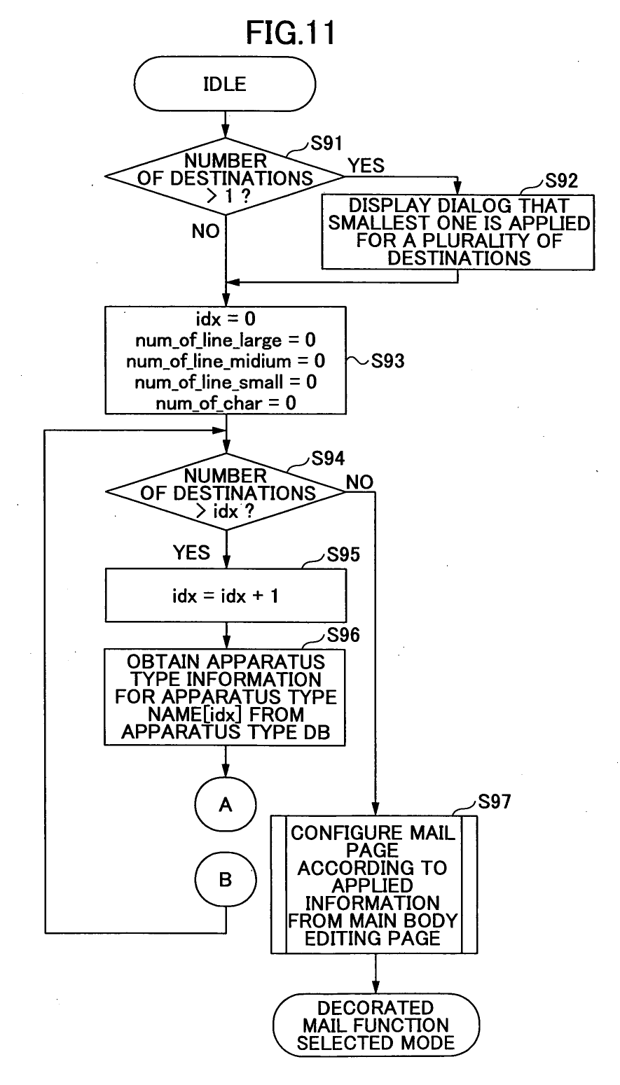

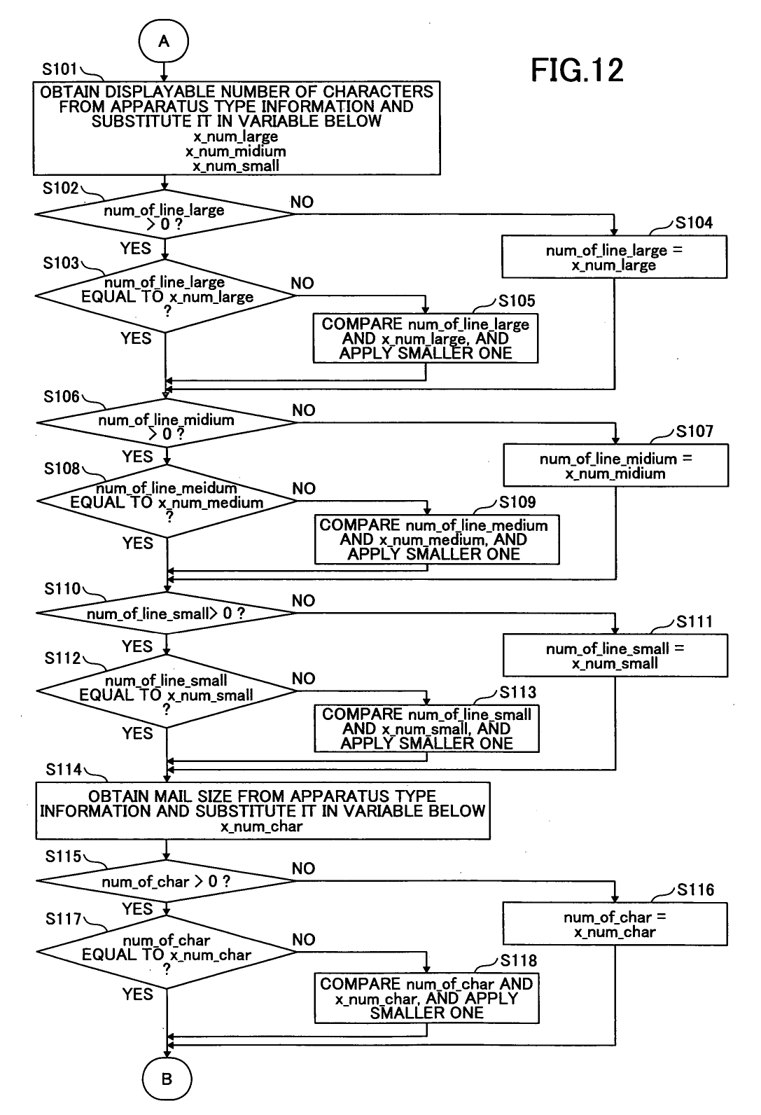

FIGS. 11 and 12 show a destination display mode operation in the edit main body mode for a case where the cellular phone has the plurality of destination processing function.

In this case, in Step S91, it is determined whether the total number of destinations is one or many. When it is many, a message that a display is made according to an apparatus type having a smaller page display capability is displayed for a user in Step S92.

It is noted that, another method of treating a case where the displayable number of characters per line is different among a plurality of destinations may be applied. That is, a message notifying of this matter may be made, and operation of adjusting a display of mail main body according to a destination apparatus type shown in FIG. 12 may not be actually carried out. In this case, a display of a mail main body is made according to the page display function of the own apparatus type accordingly.

Then, in Step S93, a destination number variable idx, a display character variable for a large character display mode, i.e., num_of_line_large, a display character variable for a medium character display mode, i.e., num_of_line_medium, a display character variable for a small character display mode, i.e., num_of_line small, and a mail size variable num_of_char, are initialized in 0.

In Step S94, it is determined whether or not the destination number variable currently processed has reached the total number of destinations. If the result thereof is No, this means that the variable has reached the total number of destinations (see FIG. 11), a mail main body is displayed on the display device 64 according to a predetermined applied requirement in Step S97. The predetermined applied requirement is obtained from operation of FIG. 12 described later. After that, the same as the above mentioned, the decorated mail function selected mode is automatically entered.

When a result of Step S94 is Yes, this means that the variable has not yet reached the total number of destinations (see FIG. 11), the destination number variable is incremented by 1 in Step S95, an apparatus type name of a currently processed destination is obtained from the above-mentioned apparatus type name array with the destination number variable idx as a key. Then, with the use of the apparatus type name thus obtained as a key, corresponding apparatus type information is obtained from the apparatus type DB, DB-1, in Step S96 (see FIG. 10).

Then, in Step S101 of FIG. 12, from the apparatus type information obtained in Step S96 of FIG. 11, the displayable number of characters for the large character display mode, the displayable number of characters for the medium character display mode and the displayable number of characters for the small character display mode are obtained, and are set in respective variables, i.e., x_num_large, x_num_medium and x_num_small. In Step S102, it is determined whether or not an effective value is already set in the variable of displayable number of characters for the large character display mode, i.e., num_of_line_large. When it has not been set yet, the value of x_num_large set in Step S101 is then set in num_of_line_large in Step S104.

If it is determined in Step S102 that an effective value has been already set, the values are compared between num_of_line_large and x_num_large in Step S103. When both are equal to one another (Yes), the value already set in num_of_line_large is applied. When both are different from one another, the smaller one is applied in Step S105. Thus, the smaller value is always applied.

Processing for a case of the medium character display mode and processing for a case of the small character display mode are carried out in the same manner in Steps S106-S109 (medium character) and in Steps S110-S113 (small character). Through such processing, the smallest value, from among those of the respective apparatus types of the plurality of destinations, is set in each of the displayable number of characters for the large character display mode, the displayable number of characters for the medium character display mode and the displayable number of characters for the small character display mode.

Next, in Step S114, a mail size (the number of characters accommodateable in a main body) information is obtained from the apparatus type information obtained in Step S96 of FIG. 11, and is set in a predetermined variable x_num_char. Then, in Step S115, it is determined whether or not an effective value is already set in the mail size variable num_of_char. When no effective value has been set, the value of x_num_char, set in Step S114, is then set in num_of_char, in Step S116.

On the other hand, when it is determined in Step S115 that an effective value has been already set, both of num_of_char and x_num_char are compared in Step S117. When both are equal to one another (Yes), the value already set in num_of_char is applied. When both are not equal, the smaller one is applied in Step S118. As a result, the smaller one is always applied.

Thus, when the cellular phone has the plurality of destination processing function, a display of a mail main body is carried out according to the destination apparatus type having the small displayable number of characters. Accordingly, when multicast transmission to a plurality of destinations is carried out, a mail main body is displayed on a cellular phone of a sender in a style in which a display will be made on a destination cellular phone having the smaller displayable number of characters.

Other functions of the above-described embodiment of the present invention are described next.

A function of carrying out a caution display for a function which is not supported (not applicable) by a destination is described first.

A case is assumed in which, an electronic mail is transmitted with the use of predetermined additional picture characters (or pictographs) for a person A registered in the phone book DB, DB-2, who is displayed on the display device 64, and a new mail production function is initiated therefrom. Then, as an apparatus type name of this person A, N502i is set in the phone book DB, DB-2 (see FIG. 13).

As shown in FIG. 10, for this apparatus type, ‘−’ is set in the item of additional picture character (or pictograph). Therefrom it is seen that the predetermined additional picture character display function is not mounted in the apparatus type.

Accordingly, when the user selects the above-mentioned additional picture character in a production of a mail main body in a state in which the person A is set as a destination of the electronic mail, the following caution message is automatically displayed for example:

‘The destination cellular phone does not support this picture character. Do you nevertheless use it?’

As a result, the user can recognize this fact, and can avoid a transmission of such a character which cannot be displayed on the destination in terms of its display function.

For a case where a destination is set after a completion of a mail main body, that is, when inputting of a destination in the input destination mode M2 is carried out after a main body production in the edit main body mode 5 is completed, the same caution message is displayed when the destination is thus set.

Next, a case is assumed where an electronic mail is produced in the above-mentioned decorated mail form, the same as the above, and a user designates the person A from the phone book DB, DB-2 and thus, the person A is displayed on the cellular phone. Then, a new mail production function is started up. In this case, N502i is set in as the apparatus type of this person in the phone book DB, DB-2 as shown in FIG. 13. As shown in FIG. 10, it is seen that this apparatus type does not have the decorated mail function.

Therefore, when the decorated mail function is selected in a state in which the person A is set as a destination of the electronic mail, the following caution message is automatically displayed for example (corresponding to ‘display caution dialog’ in Step S44 of FIG. 6 or Step S56 of FIG. 7):

‘The destination cellular phone does not support the decorated mail function. Do you nevertheless apply it?’

As a result, the user can recognize this fact, and can avoid an inconvenience resulting from a transmission of a mail main body prepared in an elaborate manner with the use of the decorated mail function, which cannot be displayed in an intended manner on the destination in terms of its display function.

Also the same as the above, for a case where a destination is set after the completion of a mail main body, that is, when inputting of a destination in the input destination mode M2 is carried out after a main body production in the edit main body mode M5 is completed, the same caution message is displayed when the destination is thus set.

Further, a case is assume where an electronic mail is sent in a manner of the above-mentioned chat mail, and for this purpose, a user makes a chat mail group setting for starting so-called ‘chatting’ with the use of the chat mail function among friends.

In this case, the same as the above, since N502i is set as the apparatus type of the person A in the phone book DB, DB-2, and it is seen from the apparatus type DB, DB-1 that the apparatus type does not support the chat mail function, the following caution message is automatically displayed for example when operation for a registration of the person A from the phone book DB in the group:

‘The person A currently selected is not allowed for a chat mail. Do you nevertheless proceed with the setting?’

As a result, the user can recognize this fact, that is, the user previously recognizes that the destination cellular phone does not support the chat mail function.

Next, a case is assumed where a phone call is made for the person A in a TV phone manner.

In this case, the same as the above, since N502i is set as the apparatus type of the person A in the phone book DB, DB-2, and it is seen from the apparatus type DB, DB-1 that the apparatus type does not support the TV phone function, the following caution message is automatically displayed for example:

‘The person A currently selected is not allowed for a TV phone. Do you nevertheless proceed with the phone call in this manner?’

As a result, the user can avoid TV phone initiation to the destination cellular phone which does not support the TV phone function.

It is assumed that a person C registered in the phone book DB, DB-2 is selected for applying a ‘call signal with melody’ attached mail. N901i is set in an apparatus type of a cellular phone of the person C as shown in FIG. 13. Since this apparatus type does not support a ‘call signal with melody (3D)’ function, a message that ‘the destination apparatus type has no function to reproduce the contents’ is displayed on the cellular phone of the user who makes an operation to apply a ‘call signal with melody’, from the mail producing page in a state in which the person C is set in a destination of the electronic mail. As a result, it is possible to avoid a transmission of such contents as that the destination cellular phone does not have a function to reproduce the same.

Specifically, the user may make a selection such that a melody including 3D data of MFi4.0 is not sent to an apparatus other than a 901i series, a selection such that such an electronic mail is not sent to a cellular phone which has a different supporting form of ADPCM data, or such.

The function of allowing a communication according to an environment of a destination, that is, the function described above with reference to FIGS. 8 through 12 concerning a display manner applied when an electronic mail is sent, is described with reference to actual examples as follows.

A case is assumed where a user operates an own cellular phone to display a person B registered in the phone book DB, DB-2 on the display device 64, and, therefrom, the user starts up new electronic mail production. F901iC is set as an apparatus type of a cellular phone of the person B in the phone book DB. Then, the user inserts a character of ‘AA’, a table, or such, especially using a plurality of lines for the single character or the table for example, in a mail main body, with the use of the above-mentioned decorated mail function.

In this case, when the destination display mode is selected from a menu in a state in which the person B is set as a destination of the electronic mail, an original display function of the cellular phone of the user, i.e., ‘12 characters per line’, is automatically replaced by ‘11 characters per line’. This is because, a display function of the above-mentioned apparatus type F901iC is ‘11 characters per line’, as shown in FIG. 10. Thus, a mail main body can be produced by a style, which will then appear for the destination person B.

It is noted that, generally speaking, a cellular phone has a function allowing a display of a mail main body in a plurality of alternative character sizes, and the displayable number of characters differs according to the character size actually applied thereamong (see FIG. 10).

Accordingly, when the above-mentioned destination display mode is applied, a selection should be made from among the ‘large character’ display mode, the ‘standard/medium character’ display mode and the ‘small character’ display mode after designating of the destination display mode.

Further, when a character display function (page display function) of a destination cellular phone provides a lateral width larger than that supported by the mailer 15 of the sender's cellular phone, a display according to the destination cellular phone cannot be achieved on the sender’s cellular phone. In this case, a method of laterally scrolling an image of the display device 64, a method of displaying a caution message indicating that ‘a lateral display on the destination is longer’ or such, may be applied.

Next, an occasion of a transmission of a text mail is described. For example, the same as the above, the person A is selected from the phone book DB and is displayed, and a new mail production is started up therefrom. Then, since N502i is set as the apparatus type of the person A in the phone book DB, ‘remaining amount indication’ is switched from ‘1000 bytes’ to ‘500 bytes’ when the destination display mode is selected from a menu in a state in which the person A is set as a destination of the electronic mail. This is because, as shown in FIG. 10, the apparatus type N502i has an accommodateable number of characters as a mail size is 250 characters in full size, which corresponds to 500 bytes.

Thus, it is possible to produce a mail main body in such a manner that the number of characters inserted therein is controlled within the main body size receivable by the destination according to the function of the destination cellular phone, which is thus recognized.

This function is achievable by an extended function of the mail application 15 and the TV phone application 12 in the embodiment of the present invention, for example.

As described above, in order to apply a style according to an apparatus type of a communication destination, various function/performance information is obtained from the apparatus type DB, DB-1 after an apparatus type of the destination communication apparatus is obtained from the phone book DB, DB-2. Then, for each particular processing carried to by a user, the thus-obtained information is referred to, and therewith, a display style is switched, a caution dialog is displayed or such, appropriately.

As a result, as described above, when a new electronic mail is created, a mail producing page can be configured based on information obtained from the apparatus type DB, DB-1. Further, it is also possible to display, for example, an applicable/not applicable (in a destination cellular phone) message for each one of a list of various optional melody attachments, based on the thus-obtained information, concerning the above-mentioned ‘call signal with melody) function.

In order to achieve these functions, the function of the phone book DB, DB-2 should be extended. Furthermore, as a function of the phone book application 14, an additional item for registering apparatus type information for a destination cellular phone in an editing page thereof, and also, the data item for the apparatus type information is provided in the phone book DB, DB-2 (see FIG. 13).

When the registration is actually made, apparatus type information should be registered in such a manner to have a correspondence with a phone number and a mail address of each destination person. Therefore, a registration page should be configured such that, after a registration of a phone number and a mail address is made, an apparatus type may be selected. Alternatively, when an icon is selected for each phone number (see FIG. 13) by a user, a cellular phone apparatus type list may be displayed automatically after a icon is selected by the user, wherefrom the user selects cellular phone apparatus type information.

The apparatus type DB, DB-1 is configured by various types of supported information for each apparatus type, as shown in FIG. 10.

Such an apparatus type DB may be originally embedded in a cellular phone, or, a configuration may be provided by which, in order to allow a corresponding function to be loaded also for a new apparatus type, sold in future, updating/manual additive modification is allowed with data downloaded via a communication network.

Further, when a carrier company (which actually handles electronic mail transfer among end users) transfers an electronic mail, the above-mentioned caution message may be displayed on a cellular phone according to information of a designated destination. However, in this case, the mail contents should be analyzed, and thus, a specific timing to do so may be difficult to determine.

Further, ‘−’ should be set in all the function items in the apparatus type DB for a destination cellular phone which belongs to a different carrier company. A similar manner may be applied also for a case where an apparatus type is not yet registered even a destination cellular phone belongs to a common carrier company. That is, a corresponding caution message may be generated also in the latter case.

Furthermore, a function may be provided by which, when a specific picture character or a pictograph is not supported by a destination cellular phone, it is converted into a display style displayable in the destination apparatus type according to a predetermined conversion table.

Further, the present invention is not limited to the above-described embodiment, and variations and modifications may be made without departing from the basic concept of the present invention claimed below.

The present application is based on Japanese Priority Application No. 2005-184448, filed on Jun. 24, 2005, the entire contents of which are hereby incorporated by reference.

What is claimed is:

1. A communication apparatus comprising:
a communication destination apparatus type registering part configured to register an apparatus type of a destination communication apparatus; and
a part providing a function corresponding to an apparatus type of a destination communication apparatus with the use of apparatus type information of the destination communication apparatus registered by said communication destination apparatus type registering part.

2. The communication apparatus as claimed in claim 1, wherein:
the function corresponding to an apparatus type of a destination communication apparatus comprises a function for allowing a creation of communication information in such a manner that the communication information is displayed on the own apparatus in the same style as that in which the same information is displayed on the destination apparatus.

3. The communication apparatus as claimed in claim 1, wherein:
the function corresponding to an apparatus type of a destination communication apparatus comprises a function of providing predetermined information to a user before an actual communication is made, as to whether or not the destination apparatus has a TV phone function.

4. The communication apparatus as claimed in claim 1, wherein:
the function corresponding to an apparatus type of a destination communication apparatus comprises a function of providing predetermined information to a user before an actual communication is made, as to whether or not the destination apparatus has a chat mail function.

5. The communication apparatus as claimed in claim 2, wherein:
in said function for allowing a creation of communication information in such a manner that the communication information is displayed on the own apparatus in the same style as that in which the same information is displayed on the destination apparatus, the style comprises the number of characters displayable in a specific direction on a screen.

6. The communication apparatus as claimed in claim 1, wherein:
said part providing a function corresponding to an apparatus type of a destination communication apparatus applies a function of a lowest grade from among respective functions of a plurality of destination apparatuses.

7. A control method for a communication apparatus comprising the steps of:
a) registering an apparatus type of a destination communication apparatus; and
b) providing a function corresponding to an apparatus type of a destination communication apparatus with the use of apparatus type information of the destination communication apparatus registered in said step a).

8. The control method as claimed in claim 7, wherein:
the function corresponding to an apparatus type of a destination communication apparatus comprises a function for allowing a creation of communication information in such a manner that the communication information is displayed on the own apparatus in the same style as that in which the same information is displayed on the destination apparatus.

9. The control method as claimed in claim 7, wherein:
the function corresponding to an apparatus type of a destination communication apparatus comprises a function of providing predetermined information to a user before an actual communication is made, as to whether or not the destination apparatus has a TV phone function.

10. The control method as claimed in claim 7, wherein:
the function corresponding to an apparatus type of a destination communication apparatus comprises a function of providing predetermined information to a user before an actual communication is made, as to whether or not the destination apparatus has a chat mail function.

11. The control method as claimed in claim 8, wherein:
in said function for allowing a creation of communication information in such a manner that the communication information is displayed on the own apparatus in the same style as that in which the same information is displayed on the destination apparatus, the style comprises the number of characters displayable in a specific direction on a screen.

12. The control method as claimed in claim 7, wherein:
in said step b) of providing a function corresponding to an apparatus type of a destination communication apparatus, a function of a lowest grade from among respective functions of a plurality of destination apparatuses is applied.

13. A computer readable information recording medium storing a program comprising instructions for causing a computer for controlling operation of a communication apparatus to act as:
a communication destination apparatus type registering part configured to register an apparatus type of a destination communication apparatus; and
a part providing a function corresponding to an apparatus type of a destination communication apparatus with the use of apparatus type information of the destination communication apparatus registered by said communication destination apparatus type registering part.

14. The computer readable information recording medium as claimed in claim 13, wherein:
the function corresponding to an apparatus type of a destination communication apparatus comprises a function for allowing a creation of communication information in such a manner that the communication information is displayed on the own apparatus in the same style as that in which the same information is displayed on the destination apparatus.

15. The computer readable information recording medium as claimed in claim 13, wherein:
the function corresponding to an apparatus type of a destination communication apparatus comprises a function of providing predetermined information to a user before an actual communication is made, as to whether or not the destination apparatus has a TV phone function.

16. The computer readable information recording medium as claimed in claim 13, wherein:
the function corresponding to an apparatus type of a destination communication apparatus comprises a function of providing predetermined information to a user before an actual communication is made, as to whether or not the destination apparatus has a chat mail function.

17. The computer readable information recording medium as claimed in claim 14, wherein:
in said function for allowing a creation of communication information in such a manner that the communication information is displayed on the own apparatus in the same style as that in which the same information is displayed on the destination apparatus, the style comprises the number of characters displayable in a specific direction on a screen.

18. The computer readable information recording medium as claimed in claim 13, wherein:
said part providing a function corresponding to an apparatus type of a destination communication apparatus applies a function of a lowest grade from among respective functions of a plurality of destination apparatuses.

19. A communication destination apparatus type registration data, registering a communication destination apparatus type, wherein:
said data is configured such that, in a communication apparatus, for providing a function corresponding to an apparatus type of a destination communication apparatus, apparatus type information of the destination communication apparatus registered in said communication destination apparatus type registration data is applied.
